(19) United States
(12) Patent Application Publication
(10) Pub. No.: US 2004/0058677 A1
(43) Pub. Date: Mar. 25, 2004

(54) System and method applied in wireless communication for increasing data transmission

(75) Inventors: Lee Chang-Hung, Taoyuan (TW); Huang Tz-Shian, Taoyuan (TW)

Correspondence Address: Richard P. Berg, Esq., c/o LADAS & PARRY, Suite 2100, 5670 Wilshire Boulevard, Los Angeles, CA, 90036-5679, US

(73) Assignee: Benq Corporation

(21) Appl. No.: 10/648,173

(22) Filed: Aug. 25, 2003

(30) Foreign Application Priority Data
Sep. 19, 2002 (TW) 91121402

(51) Int. Cl. H04L 12/28

(52) U.S. Cl. 455/426.2; 370/395.5

(57) ABSTRACT

This present invention is a data processing system applying in a wireless local area network for increasing the amount of data transmission. The system compresses and decompresses the data transmitted or received by a data receiving/transmitting apparatus to increase data transmission. The system includes a transmitting device and a received device. The transmitting device determines whether to compress the transmitting data, and compresses the data with a corresponding compressing method. The received device determines whether the received data being compressed or not, and decompresses the received compressed data with a corresponding decompressing method. The invention system can compress the data transmitted by the data receiving/transmitting apparatus so that the data receiving/transmitting apparatus can transmit more data in a fixed bandwidth.

### FIELD OF THE INVENTION

The present invention relates to a data processing system and method. More particularly, the present invention relates to a data processing system that increases the amount of the data transmission for a wireless communication network.

### BACKGROUND OF THE INVENTION

The network protocol layer usually uses OSI 7 protocol layers to functionally divide the protocols and to package data. Such method is often simplified according to practical needs. Referring to FIG. 1., FIG. 1 is a schematic diagram of a conventional communication protocol layer 30 and an original data 31. When transmitting data in a conventional communication, for example WLAN, the original data 31 needs to be packaged via the application layer 32, the network layer 34, and the 802.11 a/b layer 36 for transmission. The transmitting process is briefly described as followings. The original data 31 gains a network header 33 after passing the application layer 32, and gains a 802.11 a/b header 35 after passing the 802.11 a/b layer 36 to further package into a data packet for transmission.

In a WLAN, the spectrum resource is limited. Under a regular protocol, only limited data can be transmitted with limited spectrum resource. For example, IEEE 802.11b is limited in 2.4 GHz bandwidth, and this standard allows each of the three channels operate in 11 Mbps. However, the real throughput is about 5 Mbps per channel. Thus how to improve the bandwidth under the limit of regular protocol in a communication network becomes a key issue.

### SUMMARY OF THE INVENTION

It is therefore a primary objective of the present invention to provide a data processing system and method that can effectively increase the data transmitted in a wireless communication network.

The present invention relates to a data processing system applied in a wireless local area network (WLAN). The WLAN is formed by a plurality of data receiving/transmitting apparatuses. The data receiving/transmitting apparatus can be the electro-devices of the wireless network cards or an access point (AP). The data processing system is set up in a first data receiving/transmitting apparatus to let the data receiving/transmitting apparatus proceed the receiving or transmitting data. The data processing system comprises a transmitting device and a receiving device.

The transmitting device is used to process the transmitting data to a second data receiving/transmitting apparatus in the WLAN. The transmitting device comprises a look up table, a control module, and a data compressing module.

When the data processing system transmitting data to the plurality of data receiving/transmitting apparatus, the look up table records the data compressing method and the identification number corresponding to each of the plurality of data receiving/transmitting apparatuses. The control module is used to determine a corresponding data compressing policy according to the record of the second data receiving/transmitting apparatus in the look up table before the transmitting data being transmitted to the second data receiving/transmitting apparatus. The data compressing module compresses the transmitting data according to a data compressing method which is assigned by the control module.

The receiving device is used to process a receiving data. The receiving device comprises an identity module and a data decompressing module. The identity module is used to identify whether the receiving data being compressed, and the compressing method of the received data when the receiving data is compressed. The data decompressing module is used to decompress the received data according to the data compressing method of the receiving data which is identified by the identity module.

The transmitting device further compresses the transmitting data of the data receiving/transmitting apparatus, so that the bandwidth used is smaller. In other words, the data receiving/transmitting apparatus can transmits more data in a limited bandwidth, increasing the amount of data transmission. Besides, the receiving device can apply data decompression to the compressed data, so that the data can return to its original state for reading.

The features and advantages of the invention will be more readily apparent from the following detailed description and the appended drawings.

### BRIEF DESCRIPTION OF THE APPENDED DRAWINGS

FIG. 1 is a schematic diagram of a conventional WLAN protocol layer and an original data.

FIG. 2 is a schematic diagram of a data processing system according to the present invention and a wireless local area network.

FIG. 3 is a functional block diagram of the data processing system shown in FIG. 2.

FIG. 4A is a schematic diagram of the protocol layer in the WLAN and the process of data packet according to the present invention.

FIG. 4B is a schematic diagram of the format of the compressing control header shown in FIG. 4A.

FIG. 5 is a flow chart of the predetermined data inquiring procedures of the data processing system shown in FIG. 2.

FIG. 6 is a flow chart of the method of transmitting data to the target data receiving/transmitting apparatus according to the present invention.

FIG. 7 is a flow chart of processing the receiving data according to the present invention.

### DETAILED DESCRIPTION OF THE INVENTION

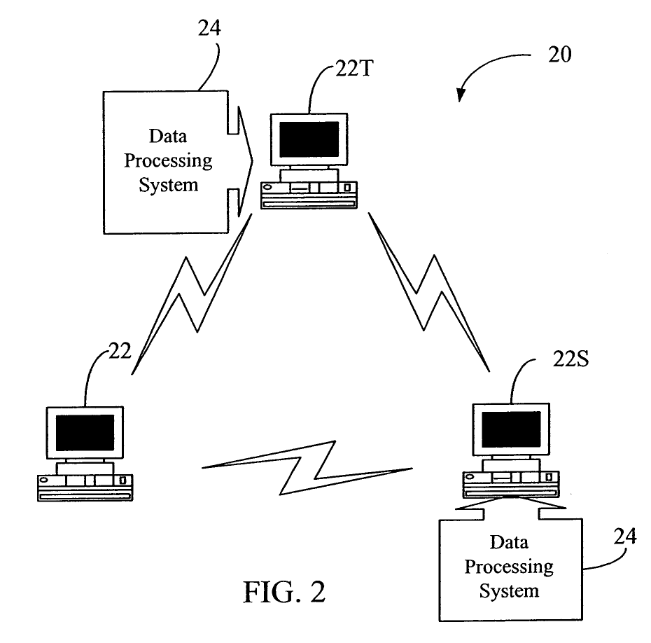

Referring to FIG. 2, FIG. 2 is a schematic diagram of a data processing system 24 according to the present invention and a wireless local area network (WLAN) 20. The data processing system 24 of the present invention is used in the wireless local area network (WLAN) 20. The WLAN 20 comprises a plurality of data receiving/transmitting apparatuses, 22, 22S and 22T shown in FIG. 2, which can transmit data to each other. The data processing system 24 is set up in the data receiving/transmitting apparatus 22S and 22T to let the data receiving/transmitting apparatus 22S and 22T proceed the receiving or transmitting data. In this embodiment, the data receiving/transmitting apparatus 22S is set to be a predetermined data transmitting device, and the data receiving/transmitting apparatus 22, 22T are set to be target data receiving/transmitting apparatuses for receiving predetermined receiving data.

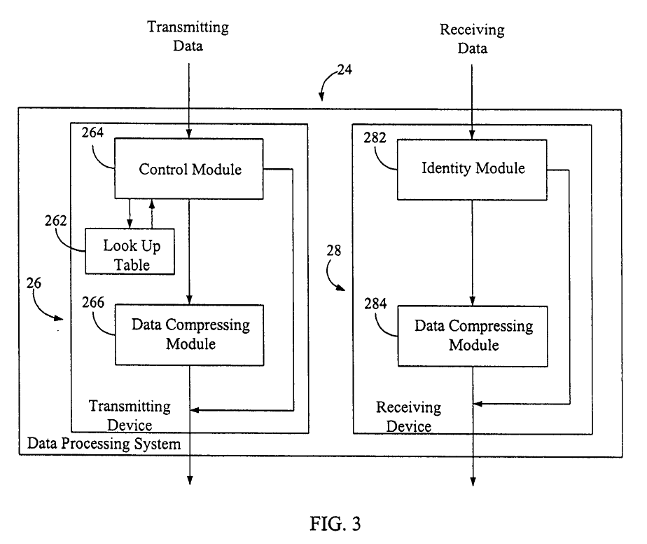

Referring to FIG. 3, FIG. 3 is a functional block diagram of the data processing system 24 shown in FIG. 2. The data processing system 24 comprises a transmitting device 26 and a receiving device 28. The transmitting device 26 is used to process a transmitting data Ds (not shown in FIG), so that the processed the transmitting data Ds can be transmitted to at least one of the target data receiving/transmitting apparatuses 22 and 22T. The receiving device 28 is used to receive and process a receiving data Dr (not shown in FIG.).

As shown in FIG. 3, the transmitting device 26 comprises a look up table 262, a control module 264, and a data compressing module 266. The look up table 262 is used for recording the data compressing method and the identification number corresponding to each of the plurality of data receiving/transmitting apparatuses. The look up table 262 comprises a plurality of records. Each record records information relating to the data previously transmitted by the transmitting device 26 to the data receiving/transmitting apparatus 22 or 22T. The information comprises that whether the data is already compressed, the corresponding compressing method used, and the device identification number of the data receiving/transmitting apparatus 22 or 22T. The device identification number means the address of the data receiving/transmitting apparatus in the WLAN. For example, because the data receiving/transmitting apparatus 22 has no data processing system 24, it cannot process the data that has been compressed. Therefore, when transmitting data from the data receiving/transmitting apparatus 22S to the data receiving/transmitting apparatus 22, no data compression occurs. Therefore, if the look up table 266 has the record of the data receiving/transmitting apparatus 22, the information of the data indicates that the data receiving/transmitting apparatus 22 does not need to process data compression. In another example, the data receiving/transmitting apparatus 22T has the data processing system 24. If it is recorded in the look up table 266, according to the information of the record, the data will be compressed by a specified data compressing method and than transmitted.

The control module 264 is used for determining a corresponding data compressing policy according to the record of the data receiving/transmitting apparatus 22 or 22T in the look up table 266 before transmitting the data to the data receiving/transmitting apparatus 22 or 22T. The control module 264 controls the data compressing module 266 to proceed the corresponding data compression by the data compressing method of the data compressing policy of the target data receiving/transmitting apparatus 22 or 22T.

As shown in FIG. 3, the receiving device 28 comprises an identity module 282 and a data decompressing module 284. By reading the information in the packet of the receiving data, the identity module 282 is used to identify whether the data has been compressed, and to identify the data compressing method of the receiving data when the receiving data has been compressed. The data decompressing module 284 is used to decompress the receiving data according to the data compressing method identified by the identity module 282.

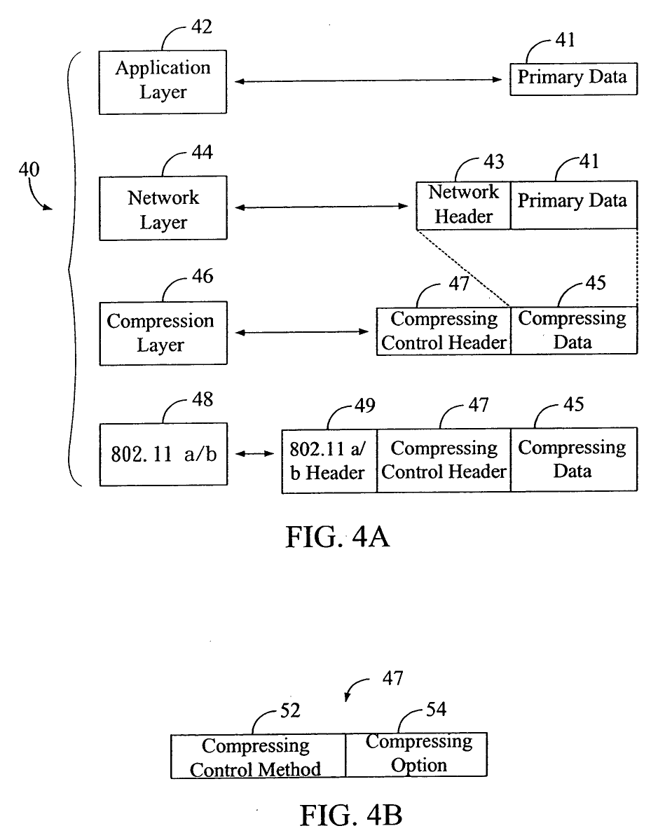

Referring to FIG. 4A, FIG. 4A is a schematic diagram of the protocol layer 40 in the WLAN 20 and the process of data packet according to the present invention. The protocol layers 40 of the present invention comprise an application layer 42, a network layer 44, a compression layer 46, and a 802.11 a/b layer 48. Compare to the conventional technology, there is a compressing layer 46 between the network layer 44 and the 802.11 a/b layer 48 in the present invention. First in the application layer 42, a primary data 41 is edited. In the network layer 44, the primary data 41 gains a network header 43 to form the transmitting data Ds. Continuously, in the compressing layer 46, the transmitting data Ds is compressed and to form a compressing data 45 and added a compressing control header 47, according to the data compressing method determined by the control module 264. Last, in the 802.11 a/b layer 48, a 802.11 a/b header 49 is added into the front of the compressing control header 47 to form a data packet for transmitting. The network header 43 is used to mark the device identification number of the data receiving/transmitting apparatus 22S and the device identification number of the target data receiving/transmitting apparatus 22 or 22T. The compressing control header 47 records the compressing control method of the transmitting data and the compressing option. Besides, the arrowheads in the FIG. 4A represent the corresponding relation between the protocol layer and the data processing format.

As shown in FIG. 4B, FIG. 4B is a schematic diagram of the format of the compressing control header 47 shown in FIG. 4A. The compressing control header 47 can be divided into two parts, a compressing control method 52 and a compressing option 54. The two parts are applied in controlling the compression of the inquiring signal, the response signal, and the data transmission. The first part, the compressing control method 52, can mark several control formats. For examples, format 1 represents the inquiring packet about that whether compression can be used or not inquiring to the target receiving/transmitting apparatus 22 or 22T. Format 2 represents the response packet about that whether the packet has been compressed and the compressing method responded by the target receiving/transmitting apparatus 22 or 22T. Format 3 represents that the packet is the data transmitting packet. The second part, the compressing option 54, can be used to deliver the compressing method chose to use, such as ZIP, LZH, etc. Besides compressing the original data, the data processing system of the present invention can further compress the data when data is packaging, resulting in an increased amount of data transmitting in a fixed bandwidth.

The data compressing policy of the present invention comprises the followings.

If the look up table 262 has already recorded the corresponding data compressing method of the target data receiving/transmitting apparatus 22 or 22T, then the control module 264 notifies the data compressing module 266 to compress the transmitting data Ds according to the data compressing method recorded in the look up table 262.

If the look up table 262 has not recorded the corresponding data compressing method of the target data receiving/transmitting apparatus 22 or 22T, then according to a predetermined data inquiring procedure, the control module 264 will determine a data processing method to process the transmitting data Ds.

For example, when the data receiving/transmitting apparatus 22S transmits the transmitting data Ds to the target data receiving/transmitting apparatus 22T, the data processing system 24 will perform the inquiring procedures of the predetermined data process as followings. First, the control module 264 of the data receiving/transmitting apparatus 22S transmits a inquiring signal or so-called inquiring packet Dc (which is the format 1 of the compressing control method in the compressing control header) to the target data receiving/transmitting apparatus 22T. Next, wait for a response signal or so-called response packet Db (which is the format 2 of the compressing control method in the compressing control header) the target data receiving/transmitting apparatus 22T. Then, proceed a predetermined response processing procedure in a predetermined waiting period for afterwards data transmission.

The response processing procedure of the control module 264 in the present invention is described as followings. When the control module 264 receives the response signal in a predetermined waiting period, the transmitting data Ds will be compressed according to the responding information of the response signal. If the control module 264 does not receive the response signal within the predetermined waiting period, the transmitting data Ds will be directly transmitted without data compression.

The response signal Db comprises response information, comprising the device identification number of the target data receiving/transmitting apparatus, whether the transmitting data should be compressed or not and the corresponding data compressing method. The device identification number is the address of the target data receiving/transmitting apparatus 22T in the WLAN 20. The data compressing method is the data compressing method of ZIP or LZH, etc. to apply the loss-less compression to the transmitting data Ds.

If the responding information of the response signal Db shows that it is unnecessary to proceed the data compression to the transmitting data Ds, the control module 264 will notify the data compressing module 266 not to apply the data compression to the transmitting data Ds, and the transmitting data Ds is transmitted directly. If the responding information of the response signal Db shows that it is necessary to proceed the data compression, the look up table 262 will create a data record recording the device identification number of the target data receiving/transmitting apparatus 12T, data compression need and the information of the corresponding data compressing method.

As mention above, if the control module 264 does not receive the response signal Db in the predetermined waiting period, the data compressing module 266 will not compress the transmitting data Ds, and transmits the transmitting data Ds directly. In this situation, the look up table 262 will gain a data record recording the device identification number of the target data receiving/transmitting apparatus 22T, and the information of unnecessary to proceed data compression. If the target data receiving/transmitting apparatus does not has the data processing system 24 (as the target data receiving/transmitting apparatus 22 in FIG. 2.), the procedures are similar to the procedures mention in this paragraph.

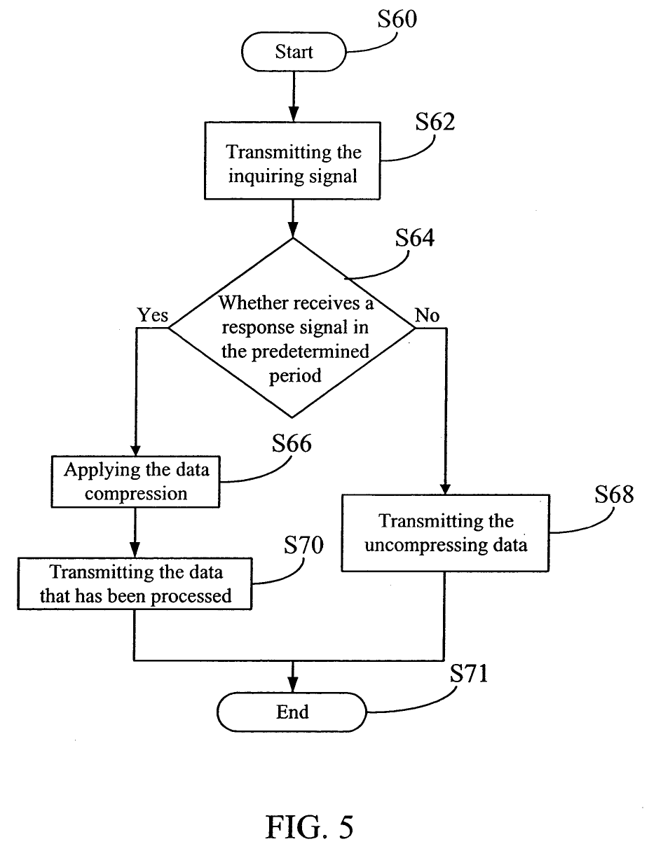

As shown in FIG. 5, FIG. 5 is a flow chart of the predetermined data inquiring procedures of the data processing system 24 shown in FIG. 2. As mention above, the predetermined data processing inquiring procedures of the data processing system 24 comprise the following steps:

Step S60: Start.

Step S62: Transmitting the inquiring signal Dc to the target data receiving/transmitting apparatus 22T, in order to establish the connection between the data receiving/transmitting apparatus 22S and the target data receiving/transmitting apparatus.

Step S64: Determining whether the data receiving/transmitting apparatus received a response signal Db from the target data receiving device in the predetermined period. If yes, go to Step S66; if not, go to Step S68.

Step S66: Applying the data compression to the transmitting data, the compressing method is proceeded according to the response single Db.

Step S68: Transmitting the uncompressing data.

Step S70: Transmitting the data that has been processed.

Step S71: End.

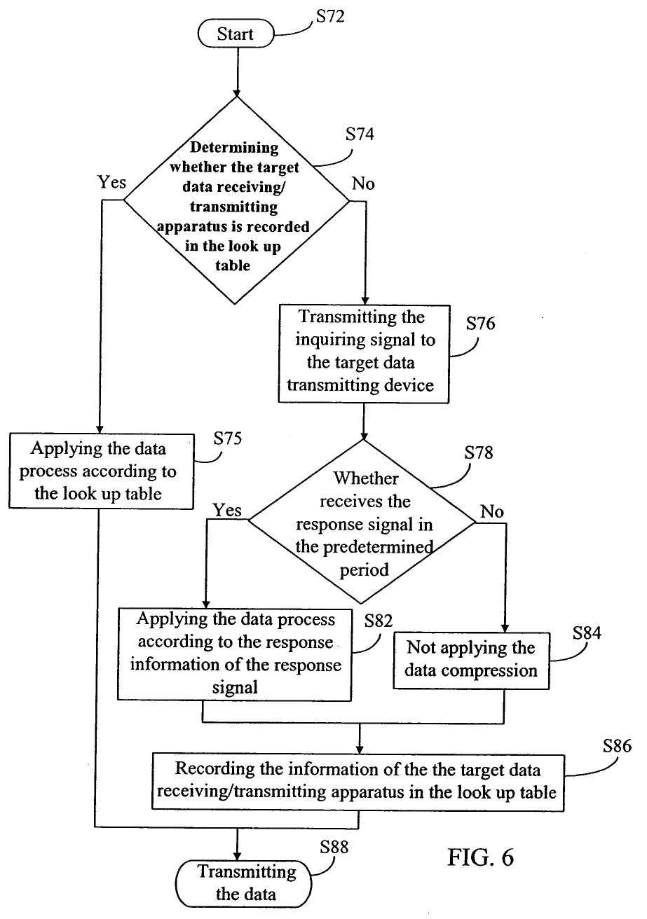

Referring to FIG. 6, FIG. 6 is a flow chart of the method of transmitting data to the target data receiving/transmitting apparatus 26T according to the present invention. The data processing method of the present invention comprises the following steps:

Step S72: Start.

Step S74: Determining whether the target data receiving/transmitting apparatus 22T is recorded in the look up table 262. If not, go to Step S76.

Step S75: Applying the data process to the transmitting data Ds according to the data compressing method recorded in the look up table 262. Then go to Step S88.

Step S76: Transmitting the inquiring signal Dc to the target data transmitting device 12T.

Step S78: Waiting for the response signal Db in the predetermined period, if receives, then go to Step S82; if not receives the response signal Db in the predetermined period, then go to Step S84.

Step S82: Applying the data process to the transmitting data according to the response information of the response signal, then go to Step S86.

Step S84: Not applying the data compression.

Step S86: Recording the device identification number of the target data receiving/transmitting apparatus, the information of whether it is necessary to proceed data compression, and the corresponding compressing method in the look up table 262.

Step S88: Transmitting the data.

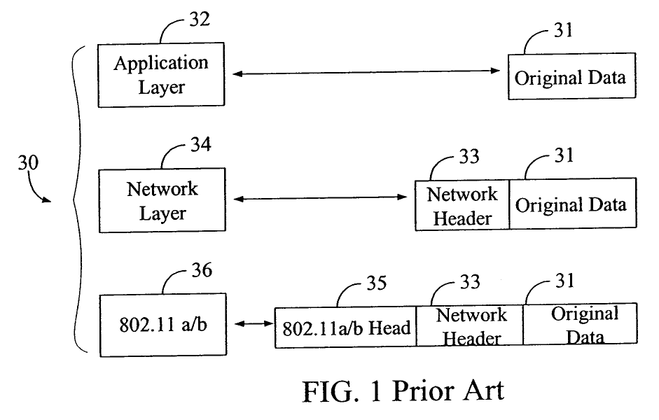

For example, the data receiving/transmitting apparatus 22S transmits the data to the target data receiving/transmitting apparatus 22T (as shown in FIG. 1). Because the target data receiving/transmitting apparatus 22T has set with the data processing system 24, the data receiving/transmitting apparatus 22S will receive the response signal when the data receiving/transmitting apparatus 22S proceeds the inquiring procedures. Therefore, the data receiving/transmitting apparatus 22S transmits the compressed data to the target data receiving/transmitting apparatus 22T.

In another example, the data receiving/transmitting apparatus 22S transmits the data to the target data receiving/transmitting apparatus 22 (as shown in FIG. 1). Because the target data receiving/transmitting apparatus 22 does not set with the data processing system 24, the data receiving/transmitting apparatus 22S will not receive the response signal. Therefore, the data receiving/transmitting apparatus 22S directly transmits the uncompressed data to the data receiving/transmitting apparatus 22.

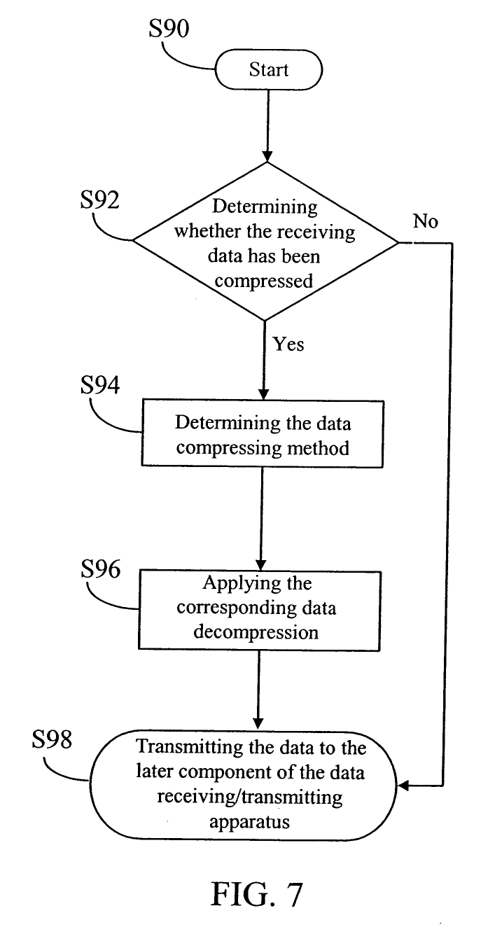

Referring to FIG. 7, FIG. 7 is a flow chart of processing the receiving data according to the present invention. The processing procedure of the receiving data according to the present invention comprises the following steps:

Step S90: Start.

Step S92: Determining whether the receiving data has been compressed according to the compressing control header 26. If not, go to Step S98.

Step S94: Identifying the data compressing method of the compressed data.

Step S96: Applying the corresponding data decompression to the receiving data according to the data compressing method.

Step S98: Transmitting the data to other following components.

According to the present invention, the transmitting device 26 further compresses the transmitting data of the data receiving/transmitting apparatus, so that the bandwidth used is smaller. In other words, the data receiving/transmitting apparatus can transmits more data in a fixed bandwidth, increasing data transmitting. Besides, the receiving device 28 can apply data decompression to the compressed data, so that the data can return to its original state for reading, and so to prevent the unreadable situation occurred for data compression.

While the invention has been described in the preferred embodiments, it is understood that the words, which have been used, are words of description rather than words of limitation and that changes within the purview of the appended claims may be made without departing from the scope and spirit of the invention in its broader aspect.

What is claimed is:

1. A data processing system applying in a wireless local areas network (WLAN), the WLAN comprising a plurality of data receiving/transmitting apparatus, the system at least being set up in a first data receiving/transmitting apparatus to let the first data receiving/transmitting apparatus proceed the received or transmitting data, the system comprising:
a transmitting device for processing the transmitting data transmitted to a second data receiving/transmitting apparatus, the transmitting device comprising:
a look up table, when the data processing system transmitting data to the plurality of data receiving/transmitting apparatus, for recording the data compressing method and the identification number corresponding to each of the plurality of data receiving/transmitting apparatus;
a control module for determining a corresponding data compressing policy according to the record of the second data receiving/transmitting apparatus in the look up table before the transmitting data being transmitted to the second data receiving/transmitting apparatus; and
a data compressing module for compressing the transmitting data according to a data compressing method which is assigned by the control module; and
a receiving device for processing a receiving data, the receiving device comprising:
an identity module for identifying the data compressing method of the received data; and
a data decompressing module for decompressing the received data according to the data compressing method which is identified by the identity module.

2. The data processing system of claim 1, wherein the data compressing policy comprises:
if the data compressing method used by the second data receiving/transmitting apparatus has been recorded into the look up table, the control module notifying the data compressing module to compress the data according to the data compressing method recorded in the look up table; and
if the data compressing method used by the second data receiving/transmitting apparatus hasn't been recorded into the look up table, the control module determining a process to negotiate with the second data receiving/transmitting apparatus by a predetermined inquiring procedure.

3. The data processing system of claim 2, wherein the inquiring procedure comprises;
transmitting an inquiring signal to the second data receiving/transmitting apparatus;
waiting for a response signal responded by the second data receiving/transmitting apparatus; and
proceeding a predetermined responding processing procedure in a predetermined waiting period, for following up with transmitting the data.

4. The data processing system of claim 3, wherein the response signal comprises following responding information:
whether the transmitting data should be compressed; and
the data compressing method being used when the transmitting data should be compressed.

5. The data processing system of claim 4, wherein the responding processing procedure comprises:
if receiving the response signal in the predetermined waiting period, then processing the transmitting data according to the responding information of the response signal; and
if not receiving the response signal in the predetermined waiting period, then directly transmitting the transmitting data without compressing.

6. The data processing system of claim 5, wherein, when the responding information of the response signal shows unnecessary to proceed the data compression, the control module notifies the data compressing module not to proceed the compressing procedure, and transmits the transmitting data directly.

7. The data processing system of claim 5, wherein, when the responding information of the response signal shows necessary to proceed the data compression, the look up table creates a data record to record the device identification number of the second data receiving/transmitting apparatus, the information of data compression, and the information of the corresponding data compressing method into the look up table.

8. The data processing system of claim 5, wherein, when the responding information of the response signal shows unnecessary to proceed the data compression, the look up table creates a data record to record the device identification number of the second data receiving/transmitting apparatus, the information of unnecessarily proceeding data compression into the look up table.

9. The data processing system of claim 5, wherein, if not receiving the responding data in the predetermined waiting period, the look up table creates a data record to record the device identification number of the second data receiving/transmitting apparatus, the information of unnecessarily proceeding data compression into the look up table.

10. The data processing system of claim 1, the data compressing method is to compress the transmitting data during performing the data packet packaging procedure.

11. The data processing system of claim 10, wherein the data compressing method is to proceed the loss-less compression with the transmitting data by the data compressing method of ZIP or LZH.

12. A data processing method of wireless local areas network (WLAN), the WLAN comprises pluralities of data receiving/transmitting apparatus, the processing method processes a transmitting data at least in one data receiving/transmitting apparatus, for following up with transmitting the transmitting data to a target data receiving/transmitting apparatus of the WLAN, the data receiving/transmitting apparatus comprising a look up table, the look up table comprising a plurality of data records for recording the data compressing method and the identification number corresponding to each of the plurality of data receiving/transmitting apparatus when the data processing system transmitting data to the plurality of data receiving/transmitting apparatus, the data processing method comprises;
determining a corresponding data compressing policy according to the record of the target data receiving/transmitting apparatus in the look up table before the transmitting data being transmitted to the target data receiving/transmitting apparatus; and
compressing the transmitting data according to a data compressing method recorded in the data compressing policy.

13. The data processing method of claim 12, wherein the transmitting data comprises a header and a main data.

14. The data processing method of claim 12, wherein the data compressing policy comprises:
if the data compressing method used by the target data receiving/transmitting apparatus has been recorded into the look up table, compressing the transmitting data according to the data compressing method recorded in the look up table; and
if the data compressing method used by the target data receiving/transmitting apparatus hasn't been recorded into the look up table, determining a process to process the transmitting data according to a predetermined inquiring procedure.

15. The data processing method of claim 14, wherein the inquiring procedure comprises;
transmitting an inquiring signal to the target data receiving/transmitting apparatus;
waiting for a response signal responded by the target data receiving/transmitting apparatus; and
proceeding a predetermined responding processing procedure in a predetermined waiting period, for following up with transmitting the data.

16. The data processing method of claim 15, wherein the response signal comprises the following response signal information:
whether the transmitting data should be compressed; and
the data compressing method being used when the transmitting data should be compressed.

17. The data processing method of claim 15, wherein the response signal processing procedure comprises:
if receiving the response signal in the predetermined waiting period, then processing the transmitting data according to the responding information of the response signal; and
if not receiving the response signal in the predetermined waiting period, then directly transmitting the transmitting data without compressing.

18. The data processing method of claim 17, wherein, when the responding information of the response signal shows unnecessary to proceed the data compression, then the data receiving/transmitting apparatus doesn't compress the transmitting data, and transmits the transmitting data directly.

19. The data processing method of claim 17, wherein, if the responding information of the response signal shows necessary to proceed the data compression, the look up table creates a data record to record the device identification number of the target data receiving/transmitting apparatus, the information of data compression, and the information of the corresponding data compressing method into the look up table.

20. The data processing method of claim 17, wherein, if the responding information of the response signal shows unnecessary to proceed the data compression, the look up table creates a data record to record the device identification number of the target data receiving/transmitting apparatus, the information of not proceeding data compression into the look up table.

21. The data processing method of claim 17, wherein, if not receiving the response signal in the predetermined waiting period, the look up table creates a data record to record the device identification number of the target data receiving/transmitting apparatus, the information of not proceeding data compression into the look up table.

22. The data processing method of claim 12, wherein the data compressing method is to compress the transmitting data during performing the data packet packaging procedure.

23. The data processing method of claim 22, wherein the data compressing method is to proceed the loss-less compression with the transmitting data by the data compressing method of ZIP or LZH.
